(19) United States
(12) Patent Application Publication
(10) Pub. No.: US 2014/0248479 A1
(43) Pub. Date: Sep. 4, 2014

(54) COATING HAVING A HIGH CORONA RESISTANCE AND PRODUCTION METHOD THEREFOR

(71) Applicant: Siemens Aktiengesellschaft, Munchen (DE)

(72) Inventors: Sven Pihale, Stopfenheim (DE); Christian Seidel, Schwaig (DE)

(73) Assignee: Siemens Aktiengesellschaft, Munchen (DE)

(21) Appl. No.: 14/179,028

(22) Filed: Feb. 12, 2014

Related U.S. Application Data
(63) Continuation of application No. PCT/EP2012/064476, filed on Jul. 24, 2012.

(30) Foreign Application Priority Data
Aug. 12, 2011 (DE) 10 2011 080 884.1

(51) Int. Cl. H01B 3/30; H01B 19/04

(52) U.S. Cl. CPC H01B 3/30; H01B 19/04
USPC 428/216; 428/220; 427/58; 427/126.3

(57) ABSTRACT

A coating for a polymeric insulating material, includes 1 to 10 layers, each of the 1-10 layers having a coat thickness in a range from 0.1 to 100 μm and being wet-chemically produced from at least one precursor selected from the group consisting of silane, siloxane and silicate. The coating is silicatic and includes a silicatic base unit with organic radicals at a ratio so as to enable application of the coating onto flexible substrates.

### CROSS-REFERENCES TO RELATED APPLICATIONS

This application is a continuation of prior filed copending PCT International application no PCT/EP2012/064476, filed Jul. 24, 2012 which designated the United States and on which priority is claimed under 35 U.S.C. §120, which claims the priority of German Patent Application, Serial No. 10 2011 080 884.1, filed Aug. 12, 2011, pursuant to 35 U.S.C. 119(a)-(d) the disclosure of which is hereby incorporated by reference.

### BACKGROUND OF THE INVENTION

The present invention relates to a coating for a plastic. The coatings may be applied not only to three-dimensional components but also to sheet materials such as films and woven fabrics.

The following discussion of related art is provided to assist the reader in understanding the advantages of the invention, and is not to be construed as an admission that this related art is prior art to this invention.

Electrical machines (transformers motors, generators) posses a complex insulating system in accordance with their power and mode of construction. Polymeric materials for this application have highly suitable electrical insulation properties and are inexpensive and simple to adapt to the required geometry. A disadvantage of these materials in general is a low long-term stability to electrical discharges at high field strength.

It would therefore be desirable and advantageous to provide a material having improved corona stability and comprising the advantages of the polymeric materials

### SUMMARY OF THE INVENTION

The present invention accordingly provides a coating for a polymeric insulating material that comprises 1 to 10 layers and is fundamentally silicatic, the coating comprising a suitable blend of the silicatic base unit with organic radicals, to allow it to be applied to flexible substrates, and the coat thickness of the individual layer being in the range from 0.1 to 100 μm, the individual layers being wet-chemically producible, the precursors being silane, siloxane and/or silicate. The invention further provides a method for producing a coating for a polymeric insulating material, the coating being applied, via a wet-chemical process, in one or more layers each of which, after curing, produces a compact coat having a thickness in the range from 0.1 to 100 μm per layer.

The present coating is fundamentally silicatic, meaning that the main construction of the individual layers comprises in each case Si—O units, which are responsible for the high corona stability, but, in order to be readily applicable to flexible or pliant supports, also comprise—according to layer—different organic radicals and/or organic radicals in different concentrations, which are responsible for flexibility of the coat and/or adhesion of the coating to the flexible surfaces.

According to one advantageous embodiment, the silane precursors are tetraethyl orthosilicate (TEOS) and/or methyltriethoxysilane (MTES).

Examples of suitable organic radicals are modified organosilanes which comprise epoxide, amino, acrylate, and/or vinyl groups as functional groups. In this case a hybrid polymer coat is produced.

On three-dimensional components and also on sheet materials such as films and woven fabrics, the silicatic coating has a coat thickness in the 0.1 to 100 μm range, preferably in the range from 0.1 to 50 μm, per layer.

The coating may comprise a total of 1 to 10 layers, and advantageously it comprises 1 to 5 layers and especially preferably 1 to 3 layers.

According to one advantageous embodiment, in which, in particular, the coat thickness of the coating and its flexibility is increased, the coating, as well as comprising the silane and/or siloxane component, further comprises a conventional resin system such as epoxy, unsaturated polyester, polyester, phenolic, cyanate, vinyl ester, or other known resin systems.

The resin systems or the coating sol itself here may further comprise fillers, as for example metal-oxide materials, silicon oxide, aluminum oxide, silicon carbide and/or silicon nitride, or any known further particulate materials which raise the thermal conductivity in comparison to unfilled polymers/silicatic coats.

The purpose of the individual layers is to adapt the mechanical properties of the coating. In order to compensate mechanical stresses in the case of flexible tapes and films, or because of differences in thermal expansion between coating substrate and coating, a gradient construction of polymer-elastic structure of the coating layer near to the substrate and highly inorganic structure of the coating layer away from the substrate is realized here.

It is advantageous, accordingly, if the coating in total comprises a plurality of layers, and for the layer which is adjacent—for example—to the polymeric insulator has the highest fraction of organic radicals, for flexibilization, and the layer which is situated outermost has the highest fraction of Si—O units, to ensure the corona stability.

In accordance with the invention it is possible to realize inexpensive, new, corona-stable materials solutions that can be produced and used robustly. With the materials approaches proposed here, it is possible, by adjusting the hybrid character (organic and inorganic crosslinking structure), to adjust the mechanical properties (hardness, brittleness, flexibility) within a wide range, especially for the sector of the flexible coating of sheet materials.

It is possible, accordingly, to design both electrically robust and mechanically robust systems, which are employed reliably even under flexural load on the sheetlike insulating materials.

In contrast to existing SiOx coats which are applied via physical processes (Physical Vapor Deposition, PVD), the coats can be so adjusted that coated film materials do not lead to accelerated embrittlement under thermal oxidative loading.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a comparison between PET insulating film coated according to the invention and an uncoated PET film, with standard deviation of the individual samples;

FIG. 2 shows a reference PET 50 μm foil without and with sol-gel coating according to the invention.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

### EXAMPLE

The different preparations were applied via a wet-chemical process. Suitable processes are knife application, spincoating, dipping, spraying in batch operation for piece substrates, and in roll-to-roll operations for continuous webs such as films or fabrics.

One materials preparation leads, for example, to a material having hybrid character, with the inorganic precursor tetraethyl orthosilicate (TEOS) being mixed with the network modifier methyltriethoxysilane (MTES) and water (H₂O). According to the molar ratio of the inorganic precursor TEOS and the organically modified alkoxysilane MTES, it is possible to generate a variation in the properties, from “silica glass” through to “silica rubber”.

Besides the organically modified alkoxysilane MTES which is already present anyway, it is also possible for an organofunctional silane that is itself also able to form a network with itself and with the other constituents to be added to the sol. 3-Glycidyloxypropyltrimethoxysilane (GPTMS) is added additionally to the TEOS:MTES sol. GPTMS is able to enter both into an inorganic network and also organic crosslinking.

The preparation was applied by a wet-chemical knifecoating process. The coating solutions were applied using a wire doctor to the PET surface, which had been cleaned with an ionizer. The coated side was allowed to evaporate/dried in air for at least 20 hours. Following evaporation, the coat was cured at 95-100° C. for 2.5 hours. The same scheme was adopted when coating the second side.

Verification of the property features with respect to erosion stability took place using the IEC 343b sliding arrangement. This arrangement is described in standard EN 60343 and is employed in accordance with the standard for the tests. With the sliding arrangement, PDs develop tangentially to the sample surface. The samples are exposed to the PD and aged over a time of 240 hours.

Recording the Surface Effects After Electrical Aging:

After exposure to PDs, samples of insulating material exhibit a wide variety of different effects on the surface. The most frequent feature is erosive ablation, which can be determined qualitatively and quantitatively by laser-optical means.

Results:

The sol of the invention forms a coat which after 240 hours allows only point erosion on the surface. The average depth of erosion for the four different sample films is 18 μm. This means that the PET film suffered local degradation only to half of the initial thickness, and there was no damage as for the reference.

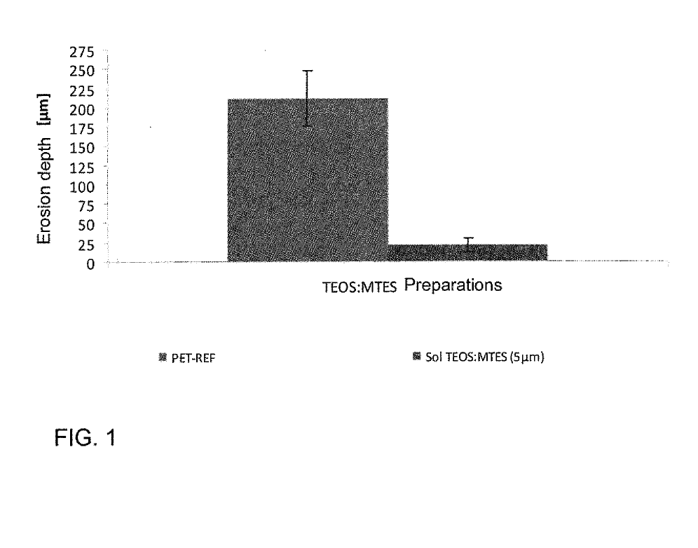

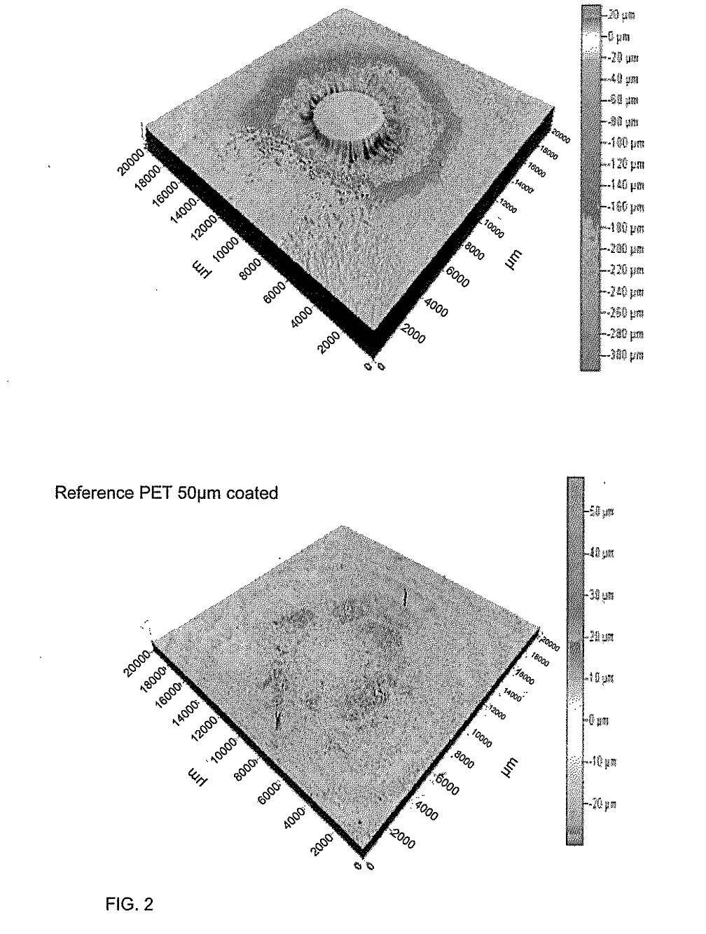

FIG. 1 shows a comparison between the coated PET insulating film and the uncoated PET film, with standard deviation of the individual samples. FIG. 2 shows a comparison between an uncoated reference PET 50 μm foil and a reference PET 50 μm foil with sol-gel coating after a 240 h erosion test.

FIGS. 1 and 2 clearly show the difference in the depth of erosion of the two samples. While the uncoated PET film exhibits a depth of erosion of almost 225 μm as a result of the test, the erosive penetration in the case of the coated film is lower by a factor of 10, at only up to 25 μm. Accordingly, the lifetime of an insulating system manufactured therefrom is increased 10-fold

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A coating for a polymeric insulating material, comprising:
1 to 10 layers, each of said layers having a coat thickness in a range from 0.1 to 100 μm and being wet-chemically produced from at least one precursor selected from the group consisting of silane, siloxane and silicate, said coating being silicatic and comprising a silicatic base unit with organic radicals at a ratio so as to enable application of the coating onto flexible substrates.

2. The coating of claim 1, wherein the silane and/or the siloxane are prepared from a precursor which comprises at least one of tetraethyl orthosilicate (TEOS) and methyltriethoxysilane.

3. The coating of claim 2, wherein a fraction of the organic radicals within the coating changes between individual ones of the layers so that a fraction of inorganic Si—O units within the coating increases outwardly in a direction away from the substrate.

4. The coating of claim 3, wherein the silicatic base unit with organic radicals are modified organosilanes which comprise as functional groups at least one of epoxide groups, amino groups, acrylate groups, and vinyl groups.

5. The coating of claim 1, further comprising fillers.

6. The coating of claim 5, wherein the fillers include at least one member selected from the group consisting of metal-oxide material, silicon oxide, aluminum oxide, silicon carbide and silicon nitride.

7. The coating of claim 1, further comprising a conventional resin system.

8. The coating of claim 7, wherein the conventional resin system includes a member selected from the group consisting of epoxy, unsaturated polyester, polyester, phenolic, cyanate, vinyl ester, or other known resin systems.

9. A method for producing a coating for a polymeric insulating material, comprising:
applying one or more layers, each of said layers being wet-chemically produced from at least one precursor selected from the group consisting of silane, siloxane and silicate, said coating being silicatic and comprising a silicatic base unit and organic radicals at a ratio so as to enable application of the coating onto flexible substrates; and
individually curing the layers, wherein each of said layers after the curing has a coat thickness in a range from 0.1 to 100 μm.

10. The method of claim 9, wherein the silane and/or the siloxane are prepared from a precursor which comprises at least one of tetraethyl orthosilicate (TEOS) and methyltriethoxysilane.

11. The method of claim 10, wherein a fraction of the organic radicals within the coating changes between individual ones of the layers so that a fraction of inorganic Si—O units within the coating increases outwardly in a direction away from the substrate.

12. The method of claim 11, wherein the silicatic base unit with organic radicals are modified organosilanes which comprise as functional groups at least one of epoxide, amino, acrylate, and vinyl groups.

13. The method of claim 9, further comprising fillers.

14. The method of claim 13, wherein the fillers include at least one member selected from the group consisting of metal-oxide material, silicon oxide, aluminum oxide, silicon carbide and silicon nitride.

15. The method of claim 9, further comprising a conventional resin system.

16. The method of claim 15, wherein the conventional resin system includes a member selected from the group consisting of epoxy, unsaturated polyester, polyester, phenolic, cyanate, vinyl ester, or other known resin systems.
